(19) United States
(12) Patent Application Publication
(10) Pub. No.: US 2022/0079170 A1
(43) Pub. Date: Mar. 17, 2022

(54) METHOD FOR DETERMINING A KNEADING STATE OF A DOUGH, SYSTEM FOR MONITORING THE KNEADING STATE AND KNEADING MACHINE

(71) Applicants: VMI, Montaigu Vendee (FR); ONIRIS - Ecole Nationale Vétérinaire, Agroalimentaire et de l'Alimentation, Nantes-Atlantique, Nantes Cedex 3 (FR); Centre National de la Recherche Scientifique, Paris Cedex 616 (FR)

(72) Inventors: Eloïse RIBETTE LANCELOT, La Chapelle Sur Erdre (FR); Joran FONTAINE, Nantes (FR); Adrien REBILLARD, La Chapelle sur Erdre (FR); Alain LE BAIL, NANTES (FR); José CHEIO DE OLIVEIRA, St Hilaire de Loulay (FR)

(21) Appl. No.: 17/477,001

(22) Filed: Sep. 16, 2021

(30) Foreign Application Priority Data
Sep. 16, 2020 (FR) 20/09383

(51) Int. Cl. A21C 1/14

(52) U.S. Cl. CPC A21C 1/146; A21C 1/1455

(57) ABSTRACT

A method for determining a kneading state of a dough such as a cereal dough, wherein the dough being-is configured to be kneaded in a kneading machine, the kneading machine comprising a plurality of having sensors configured to measure representative quantities of the dough during a kneading cycle and at least one kneading tool. The method includes the following steps:
continuously collecting the measurements of the representative quantities of the dough during the kneading cycle,
determining a kneading state based on a kneading state model defined as a function of the measurements of the representative quantities, the kneading state model being defined or adapted based on a learning phase, and
checking up the fulfillment of a kneading stop criterion based on the kneading state.

### CROSS REFERENCE TO RELATED APPLICATIONS

This application is related to and claims the benefit of French Patent Application. No. 20/09383, filed on Sep. 16, 2020, the contents of which are herein incorporated by reference in their entirety.

### TECHNICAL FIELD

The present disclosure concerns a method for determining a kneading state of a dough such as a cereal dough, as well as a system for monitoring the kneading state and a machine for kneading the dough.

### BACKGROUND

In the food industry, monitoring the different steps of a process, from the preparation of a dough until baking thereof, is a major concern for the quality of the end product. Kneading is often considered as the most important step. Indeed, several physical, chemical and physiochemical modifications occur upon kneading, during which the ingredients are mixed in a homogenous manner to form a dough having enough hydration to ensure swelling of the flour particles. Thus, a viscoelastic dough that is capable of preserving the gas cores that will grow during the fermentation phase is obtained. The kneading time and the amount of mechanical work applied to the dough have a critical impact on the development of the rheological properties of the dough. If the dough is not mixed enough or is excessively mixed beyond its growth optimum, the end product will have a poor quality. This optimum kneading time depends on the formulation and on the mixing technology and is often determined by the experience of the operators.

It is known to use sensors associated to kneading machines to be able to monitor the evolution of kneading of the dough. Nonetheless, it is difficult to determine in real-time the duration that the kneading cycle should last. For example, if the kneading duration is determined by the peak of a curve, it is difficult to determine the peak of this curve before having overpassed it.

Hence, the current systems do not allow accurately determining when kneading of a dough stops.

### SUMMARY

The present disclosure aims at solving all or part of the above-mentioned drawbacks.

To this end, the present disclosure concerns a method for determining a kneading state of a dough such as a cereal dough, the dough being configured to be kneaded in a kneading machine, the kneading machine comprising a plurality of sensors configured to measure representative quantities of the dough during a kneading cycle and at least one kneading tool, the method comprising the following steps:
continuously collecting the measurements of the representative quantities of the dough during the kneading cycle;
determining a kneading state based on a kneading state model defined as a function of the measurements of the representative quantities, the kneading state model being defined or adapted based on a learning phase;
checking up the fulfillment of a kneading stop criterion based on the kneading state.

Thus, the progress of the kneading cycle may be monitored in real-time and the stoppage of kneading may be accurately programmed, by cross-referencing of several measurements of representative quantities of the dough continuously performed throughout the kneading cycle. Moreover, this method may be carried out on different types of kneading machines. The implemented method requires little servicing and allows limiting costs.

For example, the kneading state is a quantity that corresponds to a linear combination of kneading parameters. For example, the kneading state may be expressed in the form of progress percentage.

For example, a dough is formed by a plurality of mixed ingredients. The amount of each ingredient of the plurality of ingredients forming the dough is defined by a recipe.

For example, the kneading cycle is configured to begin by mixing of the plurality of ingredients poured into the kneading machine.

In some embodiments, the determination method comprises a step including stopping the kneading cycle of the dough if the kneading stop criterion is met.

Thus, in addition to the aforementioned advantages, the determination method according to the present disclosure enables a stoppage of the kneading machine when the stop criterion is met. This improves even further the accuracy of the time of stoppage of kneading of the dough.

For example, the step including stopping the kneading cycle of the dough is automatically carried out when the kneading stop criterion is met.

In some embodiments, the learning phase comprises at least one test cycle, it may comprise in particular at least three test cycles, each test cycle comprising the steps:
continuously collecting the measurements of the representative quantities during a kneading cycle;
defining the kneading state model;
defining the kneading stop criterion.

Thus, thanks to these arrangements, in addition of the aforementioned advantages, the kneading state model and the kneading stop criterion may be defined before starting the kneading cycles intended to form end products.

The learning phase may comprise several test cycles, for example three test cycles.

In some embodiments, the learning phase comprises a step including defining ranges of values of the representative quantities corresponding to the kneading stop criterion.

Thus, in addition to the aforementioned advantages, the kneading stop criterion could be accurately defined.

In some embodiments, the learning phase comprises a step of checking up the dough allowing defining or adapting the kneading stop criterion.

Thanks to this check-up step, in addition to the aforementioned advantages, the stop criterion is accurately defined. Furthermore, the user could define or adapt the kneading stop criterion as a function of his/her preferences and his/her experience.

For example, the step of checking up the dough is carried after stoppage of kneading.

For example, the check-up step is carried out by a user. For example, the check-up step comprises a visual check-up of the dough, in particular a check-up of the aspect of a surface of the dough. For example, the check-up step comprises a check-up of the dough to the touch and/or a check-up of the dough to stretching.

In some embodiments, the learning phase comprises a statistical analysis of the measured representative quantities.

In some embodiments, the learning phase comprises a discriminant analysis of the measured representative quantities.

In some embodiments, the learning phase comprises a principal components analysis of the measured representative quantities.

In some embodiments, the representative quantities are: the heat-up of the dough;
the power of the kneading machine which is used to calculate a specific mechanical energy;
the total number of rotations of the kneading tool;
the absorbance of the dough on wavelengths comprised within a range of wavelengths, in particular within a range of infrared wavelengths.

Thus, in addition to the aforementioned advantages, the joint analysis of these representative quantities provides numerous indicators that allow accurately characterizing the kneading state of the dough.

The present disclosure further concerns a system for monitoring the kneading state for a machine for kneading a dough configured for the implementation of the method according to any of the aforementioned features, comprising:
a plurality of sensors configured to measure representative quantities of the dough during a kneading cycle;
an electronic control unit.

The system for monitoring the kneading state enables the determination of the kneading state of the dough directly online and automating the stoppage of the mixture. Moreover, this kneading state monitoring system may be adapted to different types of kneading machines, requires little servicing and is inexpensive.

The system for monitoring the kneading state may be integrated into the kneading machine.

The system for monitoring the kneading machine may also be adapted to an existing kneading machine.

The electronic control unit is configured to determine a kneading state based on a kneading state model defined as a function of the measurements of the representative quantities, the kneading state model being defined or adapted based on a learning phase.

The electronic control unit is configured to check up the fulfillment of a kneading stop criterion based on the kneading state.

The electronic control unit may also be configured to automatically stop the kneading machine when the kneading stop criterion is met.

In some embodiments, the plurality of sensors comprises a near-infrared sensor.

The representative quantity of the dough is directly and rapidly measured and the cost of this sensor is limited. The near-infrared sensor allows measuring the chemical modifications of the dough throughout the kneading cycle.

For example, the plurality of sensors comprises a temperature sensor.

For example, the plurality of sensors comprises a power sensor of the kneading machine, a speed sensor and a sensor of the total number of rotations of the kneading tool.

The present disclosure further concerns a kneading machine comprising a kneading monitoring system in accordance with the aforementioned features.

The disclosure and its advantages will be better understood from the detailed description made hereinafter of different embodiments of the disclosure provided as non-limiting examples. This description refers to the appended figure pages.

### BRIEF DESCRIPTION OF THE DRAWINGS

FIG. 1 represents a kneading machine, for example a kneader.

FIG. 2 represents a system for monitoring the kneading state.

FIG. 3 represents an example of display of the kneading state.

FIG. 4 represents the method for determining a kneading state of a dough.

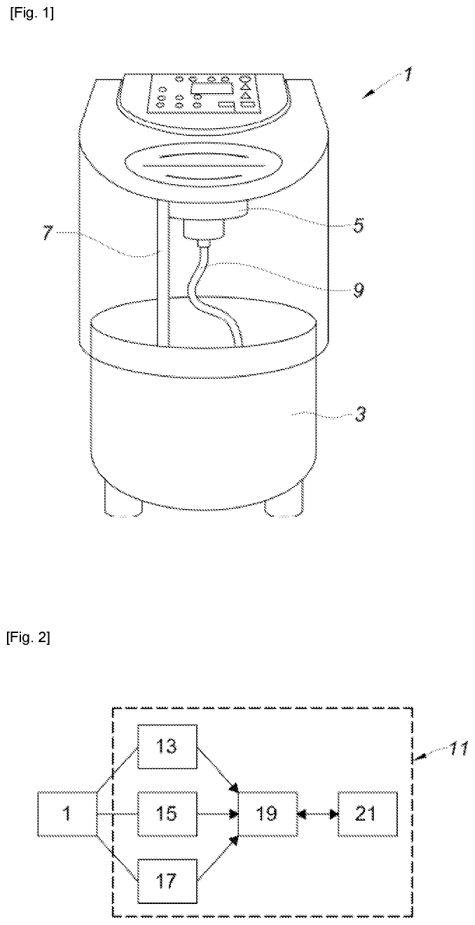

FIG. 1 represents a kneading machine 1, suited for the implementation of a kneading method described in the present disclosure.

### DETAILED DESCRIPTION OF THE DRAWINGS

Kneading of a dough is carried out in the kneading machine 1 during a kneading cycle. For example, the dough may be a cereal dough. Following the kneading cycle, the dough is generally shaped and/or baked so as to obtain an end product, for example a bread, pastry or a bakery.

The dough is characterized by a recipe and a kneading state. The kneading state results in particular from the parameters of the kneading machine 1, for example from the power or from the energy supplied throughout the kneading cycle, and from the kneading time. In general, the recipe is specific to each user. Similarly, the final desired kneading state of the dough is generally specific to each user of the machine. Indeed, each user generally uses his/her own recipe and wishes to obtain a particular kneading state at the end of the kneading cycle so that the origin of the obtained end product could be identified. Thus, for the same recipe, a user might prefer a determined kneading state, while another user would prefer another one.

The kneading machine comprises a vat 3, into which the ingredients of the dough are inserted, according to a predetermined recipe. The kneading machine 1 also comprises an arm 5 on which kneading tools 7, 9 could be mounted. The kneading tools 7, 9 are configured to be disposed at least partially inside the vat 3 so as to be in contact with the ingredients of the dough, then of the dough during kneading. In this instance, two tools 7, 9 are mounted on the kneading arm 5. A first tool 7, possibly called pivot, has an elongate and substantially linear shape. A second tool 9 has a spiral-like shape.

A system 11 for monitoring the kneading state is represented in FIG. 2. The system 11 for monitoring the kneading state comprises a plurality of sensors 13, 15, 17 allowing obtaining measurements of representative quantities of the dough. In this instance, the system 11 for monitoring the kneading state comprises a temperature sensor 13, a power sensor 15 and a near-infrared sensor 17 (SPIR).

The temperature sensor 13 is configured to measure the temperature of the dough throughout the kneading cycle. Hence, the temperature sensor 13 may be disposed in the vat 3, so as to be in contact with the dough being kneaded and carry out measurements by contact, or by a thermocouple. According to one variant, the temperature sensor 13 may also be disposed away from the dough and carry out remote measurements, for example by an infrared sensor.

The power sensor 15 is disposed at the level of the arm 5 of the kneading machine 1 and allows measuring the power of the machine. For example, the power sensor 15 is configured to measure the number of turns of the tool and the power supplied by the kneading tool 7, 9.

The SPIR 17 may be disposed at the tip of one of the first and second tools 7, 9, in this instance the first tool 7. In this instance, the SPIR 17 is configured to be in contact with the dough. Nonetheless, the SPIR 17 may also be disposed away from the dough and carry out remote measurements. The SPIR 17 is configured to measure the properties of the dough throughout the kneading, such as the water content, the starch content and the quality of the flour expressed for example by the protein content and by the absorbance of the dough on some wavelengths comprised within the range of infrared wavelengths. Indeed, these properties of the dough depend on the use recipe, but also on each kneading cycle, according to the manner in which the ingredients are mixed and the conditions of the external environment, such as the humidity or the temperature of the room in which the kneading machine 1 is disposed. Hence, these measurements may vary from one kneading cycle to another, for the same recipe and the same power of the kneading machine 1.

The kneading monitoring system also comprises an electronic control unit 19 (ECU). The ECU 19 is connected to the plurality of sensors 13, 15, 19 and is configured to collect the measurements of representative quantities performed by the different sensors of the plurality of sensors 13, 15, 17. The ECU 19 comprises a memory configured to keep the measurements of representative quantities for each kneading cycle carried out by the kneading machine 1. The ECU 19 also comprises software configured to process, throughout a kneading cycle, the measurements of representative quantities collected by the plurality of sensors 13, 15, 17. The software is also configured to analyze all of the data kept in the memory.

For example, the exploitation by the ECU 19 of the representative quantities measured by the power sensor 15 is carried out by calculating the specific mechanical energy by also by analyzing the time derivative of the curve of the values of the mechanical power as a function of the kneading time.

For example, the ECU 19 is configured to exploit the measurements of representative quantities of the temperature sensor 13 by calculating the heat-up of the dough. For this purpose, the ECU 19 is configured to compare the measurement of the initial temperature of the dough at the end of tempering with the temperature measurements collected throughout the kneading cycle.

For example, the ECU is configured to exploit the measurements of representative quantities of the SPIR 17. In particular, in this embodiment, the ECU 19 is configured to exploit the measurements performed over predetermined ranges of wavelengths. For example, the wavelengths in which measurements of water content in the dough are performed are comprised between approximately 1460 and 1930 nm. For example, the wavelength in which measurements of protein content of the flour in the dough are performed is comprised between 1460 and 1570 nm, and/or 1980 nm, and/or between 2050 and 2060 nm and/or 2180 nm.

The system 11 for monitoring the kneading state comprises a user interface 21 allowing displaying the data processed by the ECU 19. The display of the processed data enables the user to know the kneading state of the dough, and the progress of the kneading cycle.

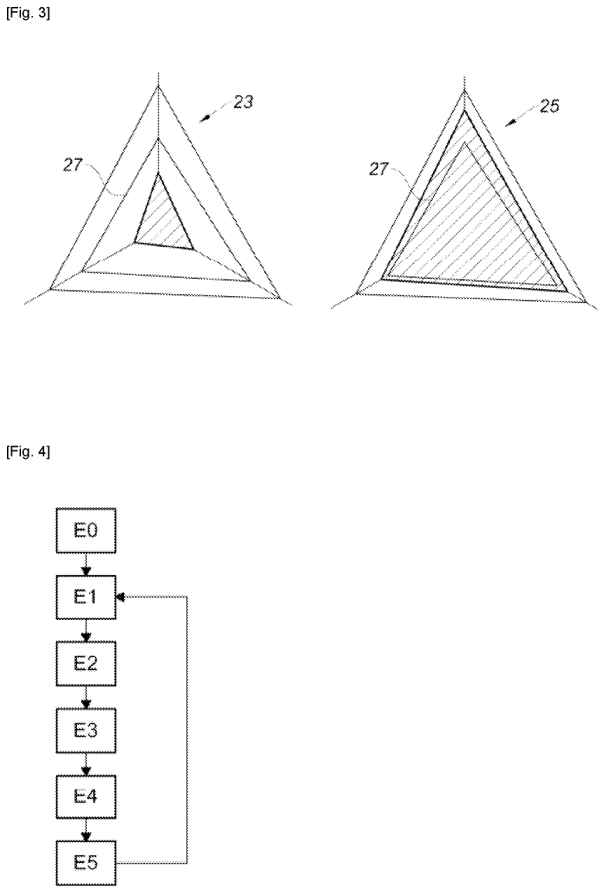

For example, the kneading state is a quantity that corresponds to a linear combination of kneading parameters. The kneading state may be expressed in different manners. For example, the kneading state may be displayed in the form of a curve or of a progress percentage. The kneading state may also be displayed in the form of a diagram 23, 25, as represented in FIG. 3, comprising a plurality of axes each corresponding to a representative quantity measured by one of the sensors of the plurality of sensors, the plurality of axes having the same origin. In this instance, the diagram comprises 3 axes corresponding to the heat-up, the energy transmitted by the kneading machine and the total number of rotations of the kneading tool. In this instance, the kneading state is represented in the form of a triangular surface defined by the progress of kneading according to each axis of the dough. In the example represented in FIG. 3, the first diagram 23 corresponds to a 45% kneading state and the second diagram 25 corresponds to a 102% kneading state. The diagrams may also allow displaying threshold values. For example, in the diagrams 23, 25, a triangle 27 corresponding to a 100% kneading state is displayed.

The user interface 21 is also configured to display warnings in the event of detection of an anomaly in the recipe by the software of the ECU 19.

The user interface 21 is also configured to transmit data input by the user to the ECU 19.

FIG. 4 represents a method for determining a kneading state implemented by the kneading monitoring system 11.

The method for determining a kneading state comprises a step E1 including continuously collecting the measurements of the representative quantities by the plurality of sensors 13, 15, 17 during a kneading cycle.

The method for determining a kneading state comprises a step E2 including determining a kneading state based on these collected measurements of representative quantities.

The determination of the kneading state is carried out by the ECU 19, based on a kneading state model defined or adapted according to the measurements of the representative quantities.

The ECU 19 is configured to define the kneading state model by the joint analysis of the measurements of the representative quantities of the plurality of sensors 13, 15, 17. For this purpose, calculation methods based on the measurements of the SPIR 17, the evolution of the number of turns of the tool 9, the energy imparted to the dough as well as the heat-up of this dough are integrated in the software of the ECU 19.

For example, the kneading state model corresponds to an addition of the representative quantities measured by each of the sensors of the plurality of sensors, multiplied by a determined coefficient. For example, the kneading state model comprises a formula of the type:

E=aA+bB+cC [Math 1]

where E corresponds to the kneading state, A, B and C are values of measured representative quantities of the dough and a, b and c are coefficients applied to each of these values. For example, A corresponds to the heat-up of the dough, B corresponds to the energy transmitted to the dough by the kneading machine and C represents the total number of rotations of the tool.

For example, in the case where the kneading state is expressed in percent, the kneading model is configured to comprise a formula allowing determining a nominal kneading state E0, which could be defined as:

E0=aA0+bB0+cC0 [Math 2]

where A0, B0and C0 are nominal values of the representative quantities of the dough.

The percentage % then corresponds to the following formula:

%=E/E0 [Math 3]

The ECU 19 may be configured to analyze the measurements of the representative quantities by a statistical analysis of the measured representative quantities during the kneading cycle and/or in the context of the learning phase.

In a first embodiment, the statistical analysis is carried out by a discriminant analysis of the measured representative quantities.

In a second embodiment, the statistical analysis is carried out by a principal components analysis of the measured representative quantities.

In a third embodiment, the software of the ECU 19 may for example associate a principal components analysis and a discriminant analysis of the measured representative quantities in order to generate the kneading state model.

For example, the kneading state model allows identifying three steps of the kneading cycle: tempering (pre-mixture), kneading (quick mixture) and over-kneading. The over-kneading state is subsequent to the maximum power peak consumed during the kneading cycle. For example, the power peak corresponds to a 100% percentage, when the kneading state is expressed in percent.

The dough kneading state model may be different for each recipe, for the same type of end product. The kneading state model may also vary over time, for the same user, according to the preferences of this user, looking for example to improve his/her end product. The user could input data that could modify the kneading stop criterion.

Hence, the kneading state model may be defined or adapted based on a learning phase. Hence, the software is configured to generate a kneading state model and afterwards analyze this kneading state model according to the preferences of the user.

In order to define a new kneading state model, the method may comprise a step E0, prior to step E1, in which a test cycle is carried out. Step E0 may be carried once or several times, for example three times.

The test cycle, comprises the following steps starting a dough kneading cycle and continuously collecting the measurements of the representative quantities. Afterwards, the test cycle comprises the step of analyzing these measurements and possibly data input by the user via the user interface 21.

For example, the test cycle could allow defining the coefficients a, b and c.

Thus, based on this kneading model, step E2 could be carried out.

This test cycle also allows defining a kneading stop criterion.

This software is configured to establish ranges of threshold values of the representative quantities corresponding to the kneading stop criterion. For example, the kneading stop criterion may correspond to the power peak of the kneading machine 1 consumed during the kneading cycle.

Nonetheless, as indicated hereinabove, the kneading stop criterion depends on the preferences and the experience of the user. Thus, this kneading stop criterion may also be defined thanks to the data input by the user via the user interface 21. For example, if the kneading state is expressed in the form of a percentage, the 100% value may correspond to the power peak of the kneading machine 1, and the kneading stop criterion may be defined by the user as corresponding to a value of the kneading state, for example 80%, or 105%. This kneading stop criterion corresponds to the kneading state deemed to be optimum by the user to obtain an end product acceptable for the latter.

For example, the kneading stop criterion may be defined by a value, for example according to a formula of the type:

CA=x [Math 4]

where CA corresponds to the kneading stop criterion and x is a numerical value corresponding to a kneading state expressed in percent.

For example, the kneading stop criterion may be defined by a range of values, for example according to a formula of the type:

y<CA<z [Math 5]

where y and z correspond to threshold values corresponding to a kneading state expressed in percent.

The method for determining a kneading state comprises a step E3 including checking up the fulfillment of the kneading stop criterion.

The method for determining a kneading state comprises a step E4 including stopping the kneading cycle if the kneading stop criterion is met. In this step, the stoppage of the kneading machine may be automatic or manual.

The kneading cycles subsequent to the test cycle, that is to say corresponding to steps E1 to E4, may also belong to the learning phase. Indeed, the ECU 19 is configured to analyze the measurements of representative quantities collected throughout these kneading cycles in the context of the learning phase. Hence, the kneading state model and the kneading stop criterion may be adapted on each kneading cycle.

The method may also comprise a step ES, subsequent to step E4, including checking up the kneading state of the dough after stoppage of the kneading machine. For example, this check-up is a visual check-up performed by the user. For example, during step E5, at least one assessment datum is supplied to the ECU 19. The ECU 19 is configured to adapt the kneading state model and the kneading stop criterion according to this assessment datum. An assessment datum may correspond to an assessment of the quality of the dough. For example the assessment datum supplied to the ECU may be «under-kneaded», «under-kneaded yet usable», kneaded», «over-kneaded yet usable»or «over-kneaded». For example, another assessment datum may correspond to a description of the aspect of the dough at the surface and to an assessment of the dough to the touch, in particular to determine the elasticity, the stiffness, or the viscosity thereof, for example.

Although the present disclosure has been described with reference to specific embodiments, modifications and changes could be made to these examples yet without departing from the general scope of the disclosure as defined by the claims. In particular, individual features of the different illustrated/mentioned embodiments may be combined in additional embodiments. Consequently, the description and the drawings shall be considered to be illustrative rather than restrictive.

All of the features described with reference to one method could be transposed, separately or in combination, to a device, and vice versa, all of the features described with reference to one device could be transposed, separately or in combination, to a method.

1. A method for determining a kneading state of a dough such as a cereal dough, the dough being configured to be kneaded in a kneading machine, the kneading machine comprising a plurality of sensors configured to measure representative quantities of the dough during a kneading cycle and at least one kneading tool, the method including the following steps:
continuously collecting the measurements of the representative quantities of the dough during the kneading cycle,
determining a kneading state based on a kneading state model defined as a function of the measurements of the representative quantities, the kneading state model being defined or adapted based on a learning phase, and
checking up the fulfillment of a kneading stop criterion based on the kneading state.

2. The determination method according to claim 1, comprising a step of stopping the kneading cycle of the dough if the kneading stop criterion is met.

3. The determination method according to claim 1, wherein the learning phase comprises at least one test cycle comprising the following steps:
a. continuously collecting the measurements of the representative quantities during a kneading cycle,
b. defining the kneading state model, and
c. defining the kneading stop criterion.

4. The determination method according to claim 1, wherein the learning phase comprises a step of defining ranges of values of the representative quantities corresponding to the kneading stop criterion.

5. The determination method according to claim 2, wherein the learning phase comprises a step of checking up the dough allowing defining or adapting the kneading stop criterion.

6. The determination method according to claim 1, wherein the learning phase comprises a statistical analysis of the measured representative quantities.

7. The determination method according to claim 6, wherein the learning phase comprises a discriminant analysis of the measured representative quantities.

8. The determination method according to claim 6, wherein the learning phase comprises a principal components analysis of the measured representative quantities.

9. The determination method according to claim 1, wherein the representative quantities are selected amongst:
the heat-up of the dough;
the power of the kneading machine which is used to calculate a specific mechanical energy;
the total number of rotations of the kneading tool; and
the absorbance of the dough on wavelengths comprised within a range of infrared wavelengths.

10. A system for monitoring a kneading state for a machine for kneading a dough configured for the implementation of a method for determining the kneading state of the dough, the dough being configured to be kneaded in a kneading machine, the machine comprising a plurality of sensors configured to measure representative quantities of the dough during a kneading cycle and at least one kneading tool, the method comprising the following steps:
continuously collecting the measurements of the representative quantities of the dough during the kneading cycle,
determining a kneading state based on a kneading state model defined as a function of the measurements of the representative quantities, the kneading state model being defined or adapted based on a learning phase, and
checking up the fulfillment of a kneading stop criterion based on the kneading state, the system comprising:
a plurality of sensors configured to measure representative quantities of the dough during a kneading cycle; and
an electronic control unit.

11. The system for monitoring the kneading state according to claim 10, wherein the plurality of sensors comprises a near-infrared sensor.

12. A machine for kneading a dough comprising a system for monitoring the kneading state according to claim 10.
